(19) United States
(12) Patent Application Publication
(10) Pub. No.: US 2005/0114787 A1
(43) Pub. Date: May 26, 2005

(54) Method and apparatus for copying information, and computer product

(75) Inventors: Kuniharu Takayama, Kawasaki (JP); Yoshiharu Maeda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/018,233

(22) Filed: Dec. 22, 2004

Related U.S. Application Data
(63) Continuation of application No. PCT/JP02/07962, filed on Aug. 5, 2002.

(51) Int. Cl. G06F 17/00

(52) U.S. Cl. 715/764

(57) ABSTRACT

An information copying apparatus includes a display processing unit that creates display mode data based on display object data and display-mode designation data stored in a first memory area, and displays a display mode corresponding to the display mode data on a first window; and a data copying unit that selects, when a copy operation for copying the display mode into a second window is performed, a part of or a whole of the display mode displayed on the window, and copies the display-mode designation data and the display object data into a second memory area corresponding to the second window.

### BACKGROUND OF THE INVENTION

1) Field of the Invention

The present invention relates to a technology for copying a display mode in a selected part into another window, in response to a copy operation, by which display object data and display-mode designation data used for creating display modes are copied so that a display mode can be changed and the display object data can be reused at a copy destination.

2) Description of the Related Art

Recently, when a computer system displays information, a display mode designation for designating a display mode for the information and the information itself are handled separately. For example, in “Extensible Stylesheet Language (XSL) 1.0”, W3C Recommendation, REC-xsl-20011015, Oct. 15, 2001, XML stylesheet language (XSL) for designating the display mode of the information described in extensible markup language (XML) is explained. The XSL can display the same information described in the XML in various display modes, by changing the description content by the XSL, that is, the designation of the display mode.

However, when a display mode created from the information described in the XML is designated by using the display mode designation described in the XSL to copy the information, there is a problem in that only the display mode is copied, and the information described in the XML and the display mode designation described in the XSL are not copied, and as such, the information cannot be reused or the display mode cannot be changed at the copy destination.

### SUMMARY OF THE INVENTION

It is an object of the present invention to solve at least the above problems in the conventional technology.

An information copying apparatus according to one aspect of the present invention includes a display processing unit that creates display mode data based on display object data and display-mode designation data stored in a first memory area, and displays a display mode corresponding to the display mode data on a first window; and a data copying unit that selects, when a copy operation for copying the display mode into a second window is performed, a part of or a whole of the display mode displayed on the window, and copies the display-mode designation data and the display object data into a second memory area corresponding to the second window.

An information copying method according to another aspect of the present invention includes creating display mode data based on display object data and display-mode designation data stored in a first memory area; displaying a display mode corresponding to the display mode data on a first window; selecting, when a copy operation for copying the display mode into a second window is performed, a part of or a whole of the display mode displayed on the window; and copying the display-mode designation data and the display object data into a second memory area corresponding to the second window.

An information copying program according to still another aspect of the present invention realizes the information copying method according to the above aspect on a computer.

A computer-readable recording medium according to still another aspect of the present invention stores the information copying program according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIGS. 1A and 1B are diagrams for explaining the concept of information duplication according to a first embodiment of the present invention;

FIG. 2 is a functional block diagram of the configuration of the information copying apparatus according to the first embodiment;

FIG. 3 is an example of NVML data;

FIG. 4 is an example of XSL data;

FIG. 5 depicts a display mode in which the NVML data shown in FIG. 3 is displayed by using the XSL data shown in FIG. 4;

FIG. 6 is a functional block diagram of the configuration of a copy source display processing unit shown in FIG. 2;

FIG. 7 is an example of display related data;

FIG. 8 is a functional block diagram of the configuration of a copying unit shown in FIG. 2;

FIG. 9 is a flowchart of the processing procedure by the copying unit;

FIG. 10 is an example of other XSL data held by a copy destination display processing unit;

FIG. 11 depicts the display mode displaying the NVML data shown in FIG. 3 by using the XSL data shown in FIG. 10;

FIG. 12 depicts a display mode in which the copy destination display processing unit converts and displays the NVML data shown in FIG. 3;

FIG. 13 explains the concept of information duplication according to a second embodiment of the present invention;

FIG. 14 is a functional block diagram of the configuration of a copying unit of an information copying apparatus according to the second embodiment; and

FIG. 15 depicts a display mode in which the copy destination display processing unit displays data in an SVG format.

### DETAILED DESCRIPTION

Exemplary embodiments of a method and an apparatus for copying information, and a computer product according to the present invention will be explained in detail with reference to the accompanying drawings.

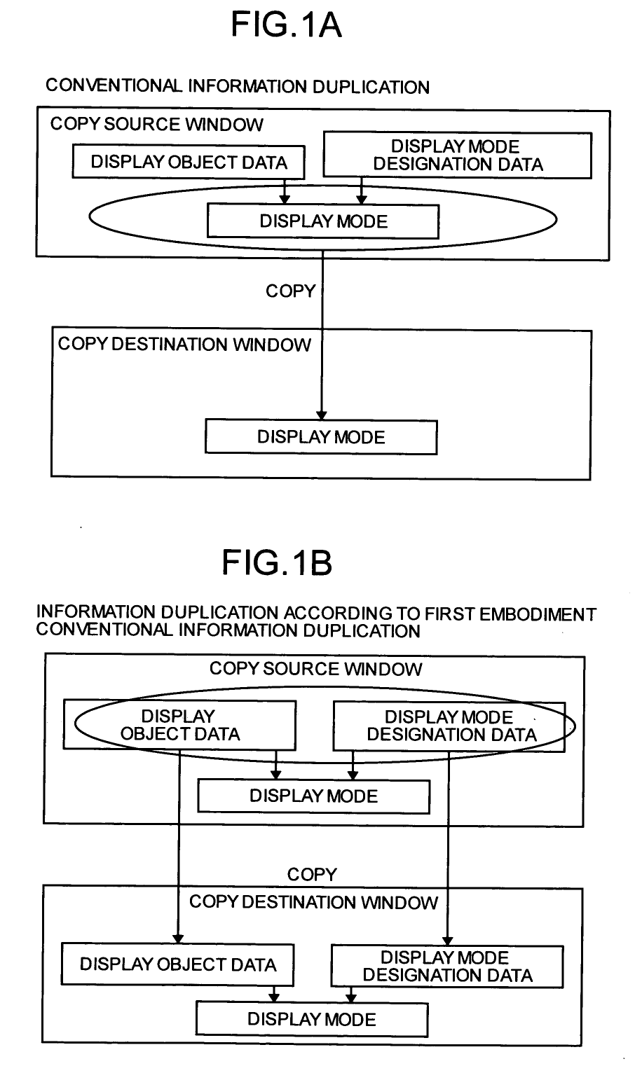

FIGS. 1A and 1B are diagrams for explaining the concept of information duplication according to a first embodiment of the present invention. As shown in FIG. 1A, in the conventional information duplication, when a display mode displayed on a copy source window is designated to make a copy, only the display mode is copied into a copy destination window, and display object data, being the original data for creating the display mode, and display-mode designation data are not copied. Therefore, the display object data cannot be displayed in a different display mode or edited on the copy destination window.

On the other hand, as shown in FIG. 1B, in information duplication according to the first embodiment, when the display mode displayed on the copy source window is designated to make a copy, the display mode is not copied, but the display object data, being the original data for creating the display mode, and the display-mode designation data are copied. The display mode is then created from the display object data based on the display-mode designation data at the copy destination, and displayed on the window.

According to the first embodiment, when the display mode displayed on the window is designated to make a copy, the display object data and the display-mode designation data are copied, without copying the display mode displayed on the window, thereby enabling change of the display mode and edit of the display object data at the copy destination.

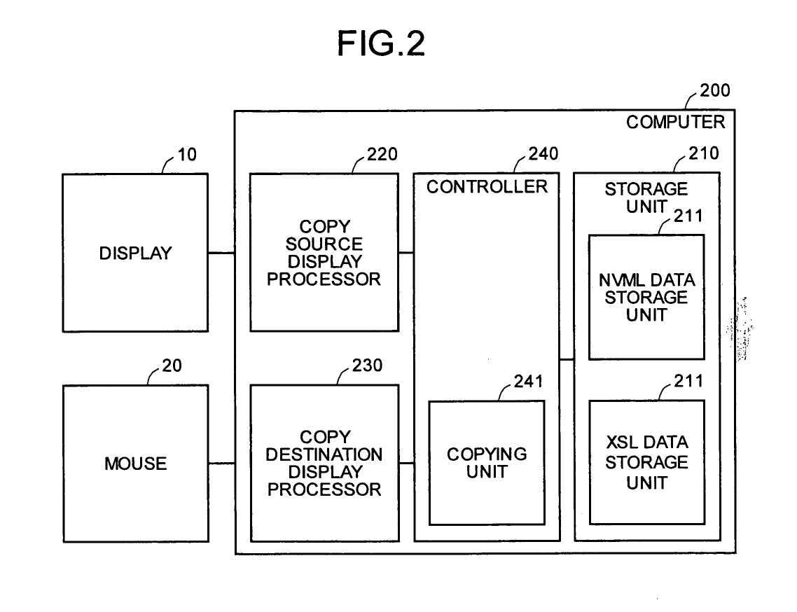

FIG. 2 is a functional block diagram of the configuration of the information copying apparatus according to the first embodiment. As shown in FIG. 2, the information copying apparatus includes a display 10, a mouse 20, and a computer 200.

The display 10 is a display unit that can display a plurality of windows, and it is used herein for displaying a copy source window and a copy destination window, when information is copied.

The mouse 20 is an input unit for designating an optional position on the display screen of the display 10, and it is used herein for designating the display mode displayed on the copy source window or the copy destination window.

The computer 200 is an apparatus that creates a display mode or duplicates information, and includes a storage unit 210, a copy source display processing unit 220, a copy destination display processing unit 230, and a controller 240.

The storage unit 210 is for storing the display object data, being an object to be copied or the display-mode designation data, and includes an NVML data storage unit 211, and an XSL data storage unit 212.

The NVML data storage unit 211 is a storage unit for storing the display object data and stores NVML data created by using the navigation markup language (NVML). Here, the NVML is a language in the XML specification for describing a position and a route of a mobile object, such as a person and a vehicle.

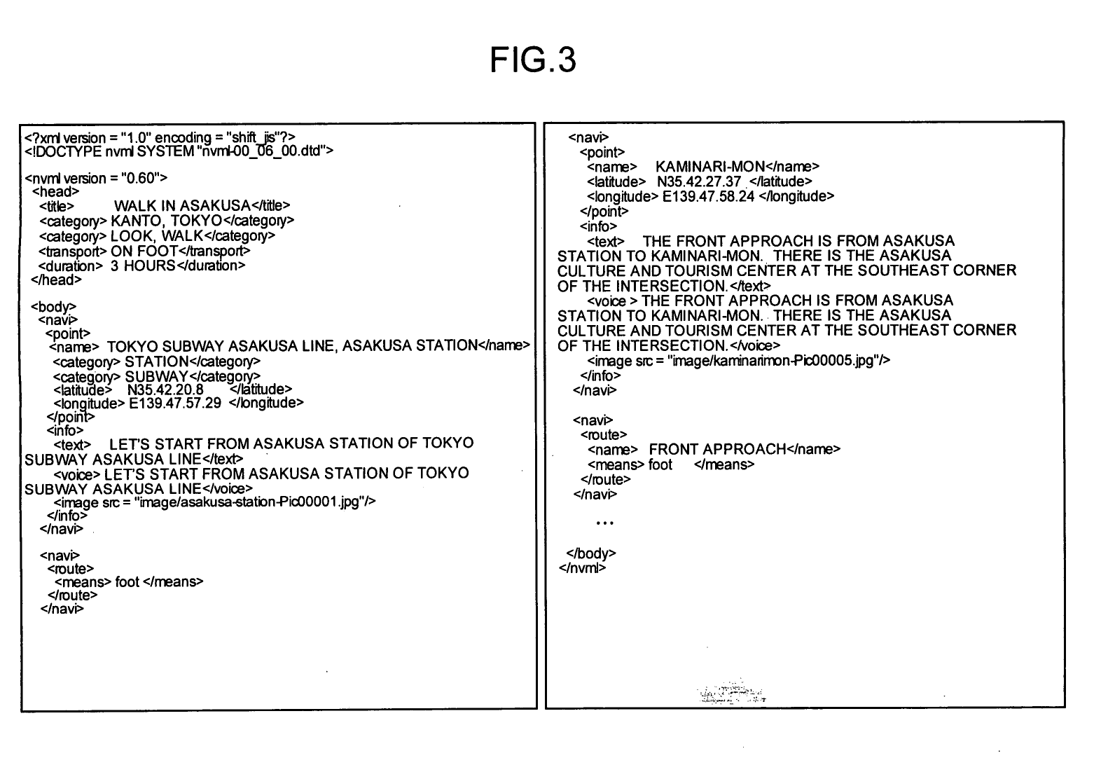

FIG. 3 is an example of the NVML data. The NVML data is basically formed of a list of navi elements and guide elements, and FIG. 3 depicts that the navi element is formed of a point element, a route element, and info element. The point element is for describing a point, the route element is for describing a route, and the info element is for describing guidance information. By using the navi element, information, for example, indicating that when the point and the route are reached via points described in the point element and routes described in the route element sequentially, the guidance information described in the respective info elements is output, can be described.

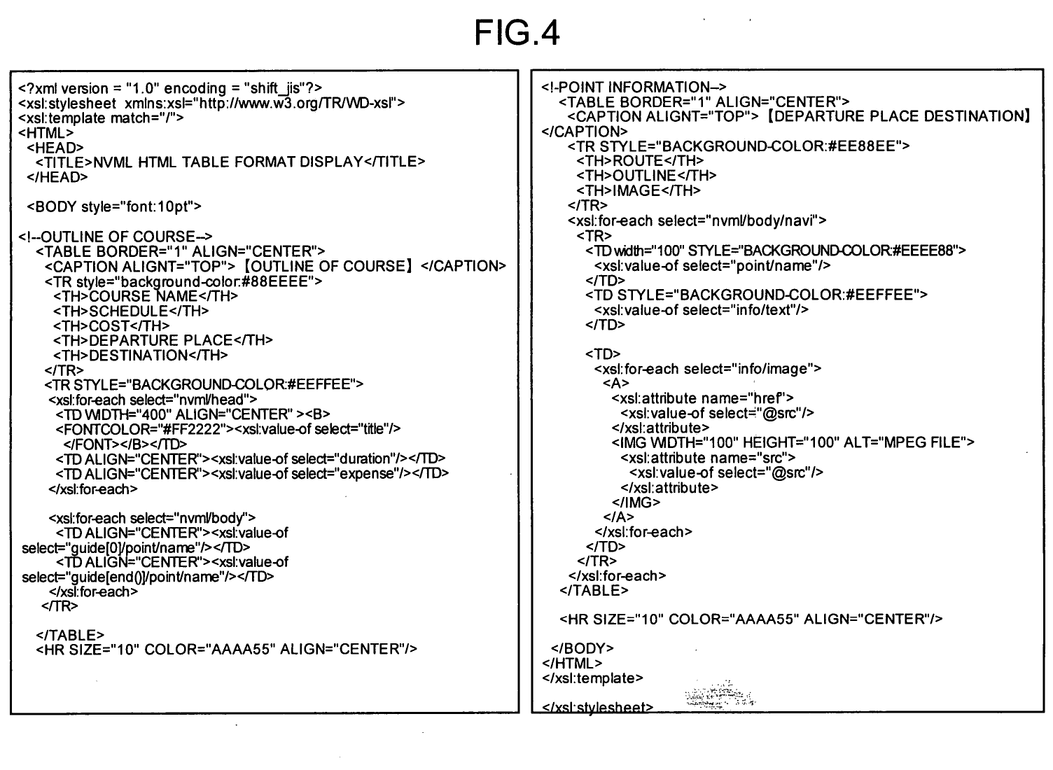

The XSL data storage unit 212 is a storage unit that stores the display-mode designation data, and stores the XSL data described by using the XSL. FIG. 4 is an example of the XSL data. FIG. 4 depicts a description for displaying the NVML data shown in FIG. 3 in a table format.

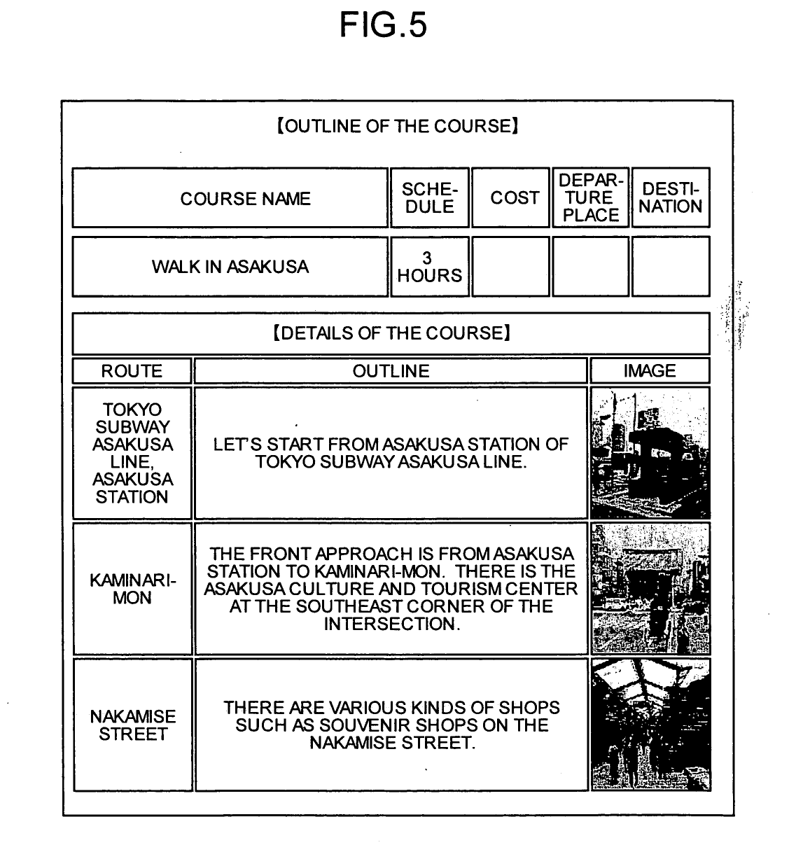

FIG. 5 depicts a display mode in which the NVML data shown in FIG. 3 is displayed by using the XSL data shown in FIG. 4. As shown in this FIG. 5, the point elements, such as “Tokyo Subway Asakusa Line, Asakusa Station” or “Kaminari-mon” in the NVML data are displayed in a table format together with the info elements, such as “Let's start from Asakusa Station of Tokyo Subway Asakusa Line” or “The front approach is from Asakusa Station to Kaminari-Mon. There is the Asakusa Culture and Tourism Center at the southeast corner of the intersection”.

The copy source display processing unit 220 is a processor that displays a copy source window, and for example, displays the display mode shown in FIG. 5 from the NVML data shown in FIG. 3, by using the XSL data shown in FIG. 4 on the window.

The copy destination display processing unit 230 is a processor that displays a copy destination window, receives the NVML data and the XSL data corresponding to the display mode of the object to be copied specified on the copy destination window, and displays the display mode created from these data on the window.

The copy source display processing unit 220 and the copy destination display processing unit 230 are an application process, and a user specifies the display mode to be displayed on the window by the copy source display processing unit 220 to make a copy on the window displayed by the copy destination display processing unit 230.

The controller 240 is a processor that controls the whole computer 200, and includes a copying unit 241. The copying unit 241 is a processor that receives data to be copied from the copy source display processing unit 220 and transmits the received data to be copied into the copy destination display processing unit 230. Specifically, the controller 240 is an operating system for the computer 200 and the copying unit 241 operates as a part of the operating system.

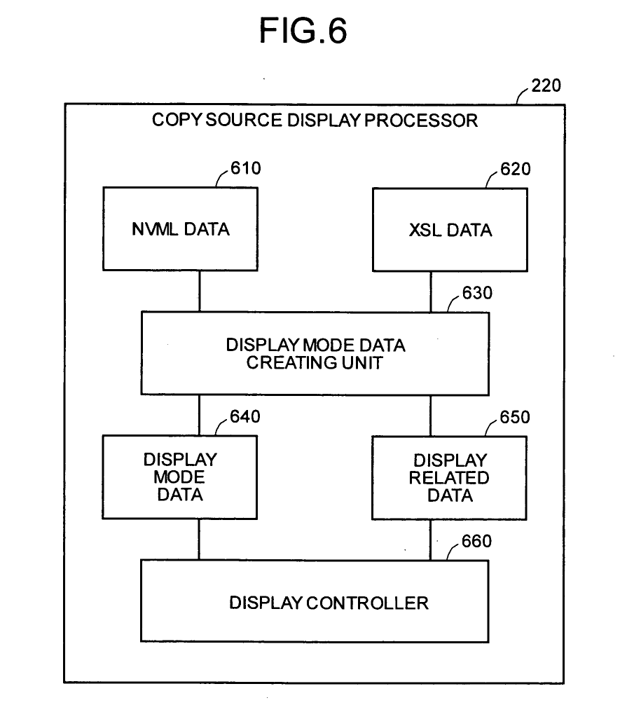

FIG. 6 is a functional block diagram of the configuration of the copy source display shown in FIG. 2. As shown in FIG. 6, the copy source display processing unit 220 includes NVML data 610, XSL data 620, a display mode data creating unit 630, display mode data 640, display related data 650, and a display controller 660.

The NVML data 610 is display object data to be copied and is data read out from the NVML data storage unit 211. The XSL data 620 is display-mode designation data to be copied together with the NVML data 610, and is data read out from the XSL data storage unit 212.

The display mode data creating unit 630 is a processor that creates the display mode data 640 from the NVML data 610 by using the XSL data 620, and creates the display related data 650 together with the display mode data 640.

The display mode data 640 is display data created from the NVML data 610 by using the XSL data 620, and the display mode data is displayed on the window as the display mode.

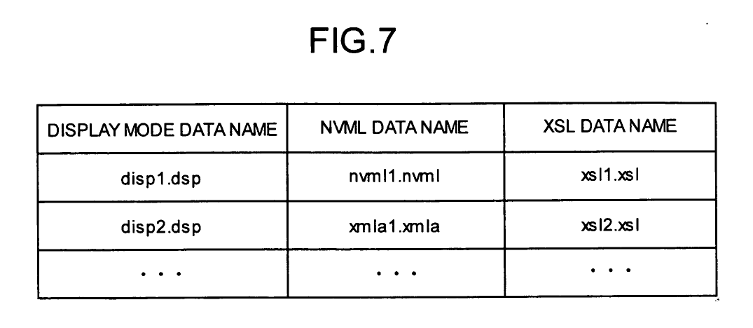

The display related data 650 depicts the relation of the NVML data 610, the XSL data 620, and the display mode data 640. FIG. 7 is an example of the display related data 650. As shown in FIG. 7, the display related data 650 is in a table format in which the NVML data 610 and the XSL data 620 used for creating the display mode data 640 are controlled for each of the display mode data 640.

For example, it is shown that the display mode data 640 in the name of disp1.dsp is created from the NVML data 610 in the name of nvml1.nvml by using the XSL data 620 in the name of xsl1.xsl. Further, it is shown that the display mode data 640 in the name of disp2.dsp is created from the NVML data 610 in the name of nvml2.nvml by using the XSL data in the name of xsl2.xsl.

Since the display related data 650 controls the NVML data 610 and the XSL data 620 used for creating the display mode for each of the display mode data 640, the NVML data 610 and the XSL data 620 can be obtained from the display mode, whereby copy instruction with respect to the display mode can be connected to the duplication of the NVML data 610 and the XSL data 620.

The display controller 660 is a processor that performs control for displaying the display mode on the window, using the display mode data 640. The display controller 660 responds to an enquiry from the copying unit 241 and hands over the NVML data 610 and the XSL data 620 to the copying unit 241.

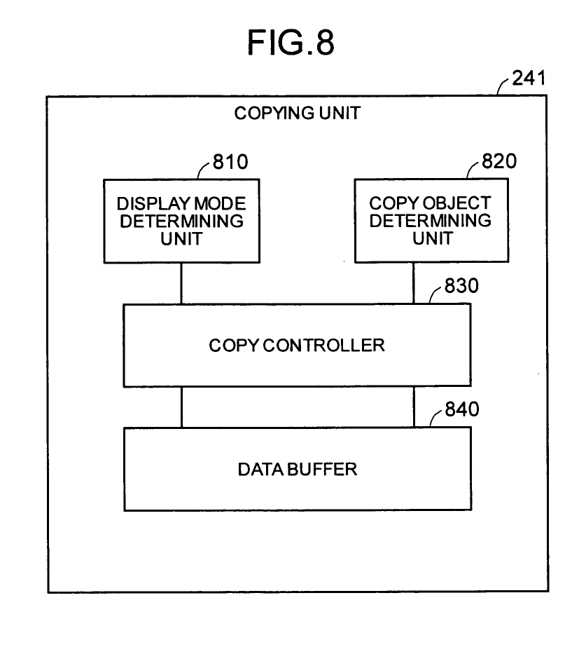

FIG. 8 is a functional block diagram of the configuration of the copying unit 241 shown in FIG. 2. As shown in FIG. 8, the copying unit 241 includes a display-mode determining unit 810, a copy object determining unit 820, a copy controller 830, and a data buffer 840.

The display-mode determining unit 810 is a processor that determines whether the display mode designated as the copy object has a display mode designation by the XSL data 620. Specifically, the display-mode determining unit 810 performs this determination by referring the presence of the display mode designation to the copy source display processing unit 220.

The copy object determining unit 820 is a processor that checks whether the copy destination display processing unit 230 has a display mode designation function using the XSL, to determine data to be copied based on the checked result. Specifically, the copy object determining unit 820 makes an investigation by referring the presence of the display mode designation function using the XSL to the copy destination display processing unit 230 to determine the data to be copied.

The copy controller 830 is a processor that copies data from the copy source display processing unit 220 into the copy destination display processing unit 230, and copies the data to be copied based on the determination result of the display-mode determining unit 810 and the determination by the copy object determining unit 820. In other words, when the display mode designated as an copy object has the display mode designation by the XSL data 620, the copy controller 830 copies not the display mode but the NVML data 610 and the XSL data 620 corresponding to the display mode from the copy source display processing unit 220 into the copy destination display processing unit 230. On the other hand, when the display mode designated as the copy object does not have the display mode designation by the XSL data 620, the copy controller 830 copies the display mode data 640 from the copy source display processing unit 220 into the copy destination display processing unit 230.

The data buffer 840 is a storage unit that temporarily stores data received from the copy source display processing unit 220, when the copy controller 830 copies data, and is used by the copy controller 830.

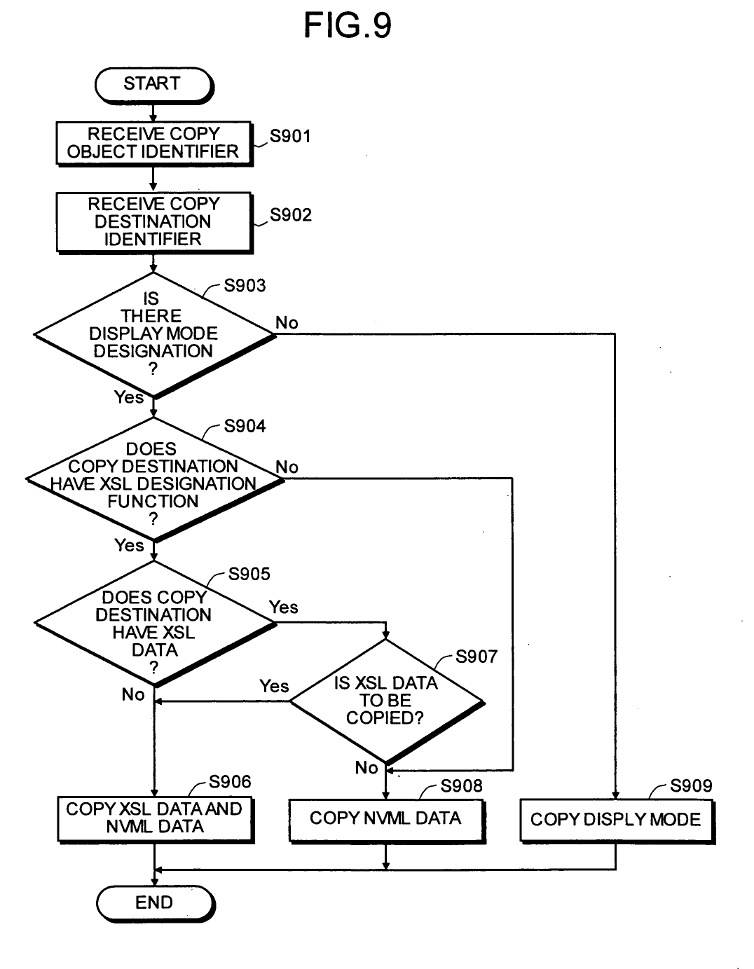

FIG. 9 is a flowchart of the processing procedure by the copying unit 241. As shown in FIG. 9, when a user selects a display mode displayed on the window by the copy source display processing unit 220 by using the mouse 20 to specify copy, the copying unit 241 receives an identifier for the copy source display processing unit 220 and a display mode identifier designated as the copy object by a process controlling the mouse 20 (step S901).

When the user specifies the window of the copy destination display processing unit 230, using the mouse 20, the copying unit 241 receives the identifier for the copy destination display processing unit 230 from the process controlling the mouse 20 (step S902).

The identifier for the copy source display processing unit 220, the display mode identifier designated as the copy object, and the identifier for the copy destination display processing unit 230 are used for an inquiry to the copy source display processing unit 220 and the copy destination display processing unit 230, and transfer of data.

The display-mode determining unit 810 determines whether the display mode designated as the copy object has the display mode designation by referring to the copy source display processing unit 220 (step S903), and when the display mode does not have the display mode designation, the copy controller 830 copies the display mode and finishes the processing (step S909).

On the other hand, when the display mode has the display mode designation, the copy object determining unit 820 checks whether the copy destination display processing unit 230 has the display mode designation function by the XSL by referring to the copy destination display processing unit 230 (step S904), and when the copy destination display processing unit 230 does not have the display mode designation function by the XSL, control proceeds to step S908 to copy only the NVML data 610.

On the other hand, when the copy destination display processing unit 230 has the display mode designation function by the XSL, the copy object determining unit 820 checks whether the copy destination display processing unit 230 has other XSL data by referring to the copy destination display processing unit 230 (step S905). When the copy destination display processing unit 230 does not have other XSL data, the copy controller 830 copies the NVML data 610 and the XSL data 620 (step S906). That is, the copy controller 830 receives the XSL data 620 and the NVML data corresponding to the display mode from the copy source display processing unit 220 and transmits the data to the copy destination display processing unit 230.

On the other hand, when the copy destination display processing unit 230 has other XSL data, the copy object determining unit 820 refers whether to copy the XSL data to the user (step S907), and when the user selects copy of the XSL data 620, the copy controller 830 copies the NVML data 610 and the XSL data 620 (step S906). On the other hand, when the user does not select copy of the XSL data, the copy controller 830 copies only the NVML data 610 (step S908). In other words, the copy controller 830 receives the NVML data 610 corresponding to the display mode from the copy source display processing unit 220 and transmits the data to the copy destination display processing unit 230.

When having received the NVML data 610 and the XSL data 620, the copy destination display processing unit 230 creates the display mode data and the display related data from the NVML data, using the received XSL data 620, and displays the display mode on the window by using the created display mode data. When the copy destination display processing unit 230 already has other XSL data and has received only the NVML data 610, the copy destination display processing unit 230 creates the display mode data and the display related data from the NVML data, using the XSL data, and displays the display mode on the window by using the created display mode data.

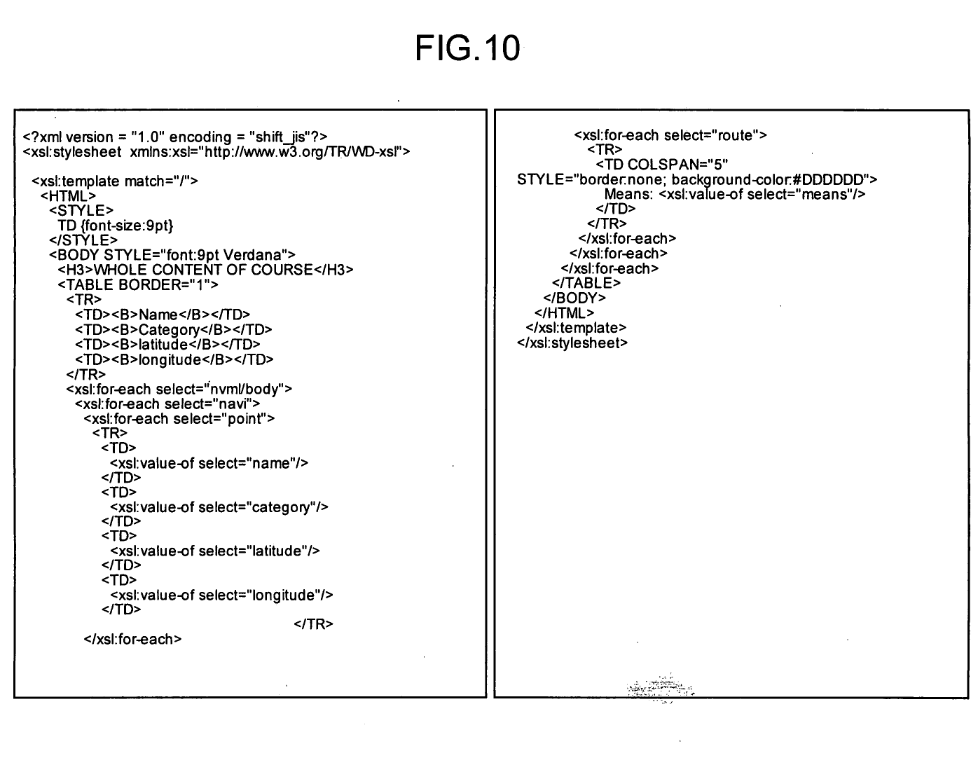

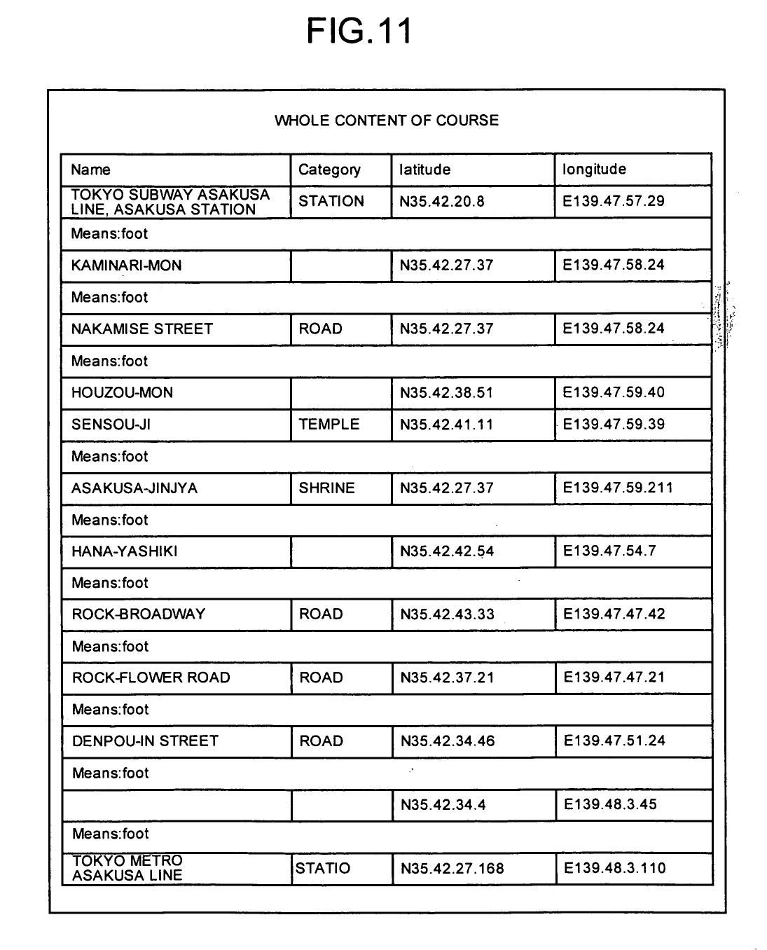

FIG. 10 is an example of other XSL data held by the copy destination display processing unit 230. FIG. 11 depicts the display mode displaying the NVML data 610 shown in FIG. 3 by using the XSL data shown in FIG. 10. FIG. 11 depicts that the same NVML data 610 can be displayed in the display mode different from that shown in FIG. 5 by changing the XSL data. In other words, since the copying unit 241 copies the NVML data 610 corresponding to the display mode, not the display mode, even in the case of copying designating the display mode, the copy destination display processing unit 230 can display the NVML data 610 by another display mode.

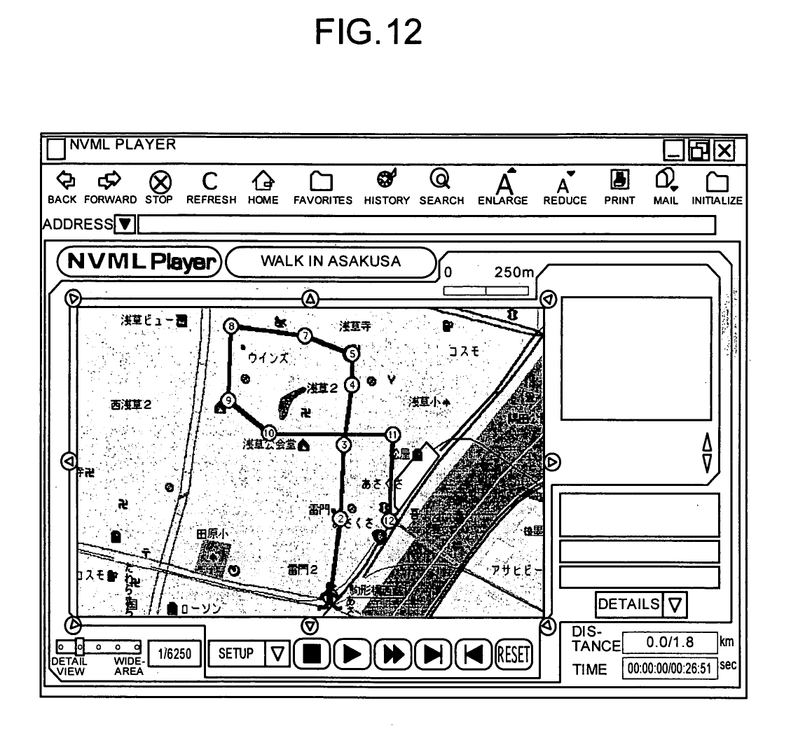

FIG. 12 depicts a display mode in which the copy destination display processing unit 230 converts and displays the NVML data 610 shown in FIG. 3. As shown in FIG. 12, since the copying unit 241 copies the NVML data 610 corresponding to the display mode, not the display mode, even when the copy destination display processing unit 230 does not have the display mode designation function by the XSL, an application can edit and display the NVML data 610.

According to the first embodiment, the copying unit 241 does not copy the display mode of the object to be copied specified by a user by using the mouse 20, but copies the NVML data 610 and the XSL data 620 used for the creation of the display mode from the copy source display processing unit 220 into the copy destination display processing unit 230. As a result, the copy destination display processing unit 230 can display the same NVML data 610 by using other XSL data, or an application can process the NVML data 610 and display it in another display mode.

In the first embodiment, an example in which when the copy destination display processing unit 230 does not have the display mode designation function by the XSL, the application processes and displays the NVML data 610 has been explained. However, when the data format handled by the application has been known already, the NVML data 610 can be converted into the data format and copied. Accordingly, in a second embodiment of the present invention, an information copying apparatus that automatically converts the data format and copies the NVML data 610 will be explained.

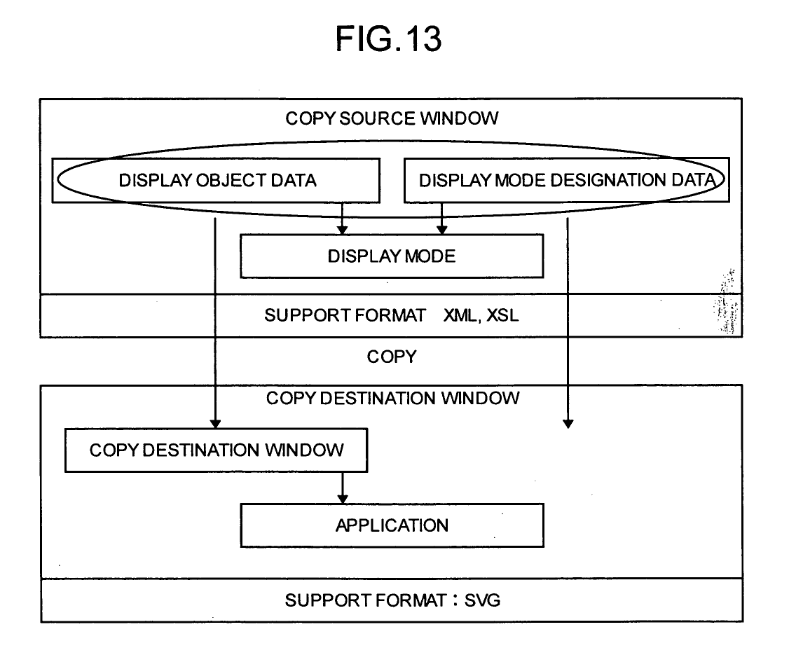

FIG. 13 explains the concept of information duplication according to the second embodiment. As shown in FIG. 13, in the information duplication, the copy destination window does not have the display mode designation function by the XSL. However, the copy destination window can display data in a scalable vector graphics (SVG) format. In this information duplication, the NVML data 610 corresponding to the display mode is not simply copied, but the NVML data 610 is converted into the SVG format and copied.

In the information duplication according to the second embodiment, since data format that can be displayed on the copy destination window is determined and the NVML data 610 is automatically converted into the data format in the copy destination, on the copy destination window, it is not necessary to perform conversion processing for displaying the duplicated display object data, and direct display on the window is possible.

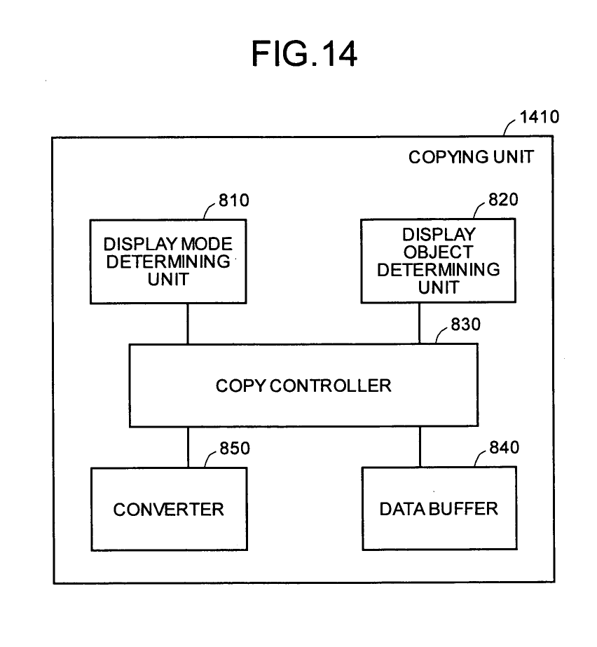

In the configuration of the information copying apparatus according to the second embodiment, only the configuration of the copying unit is different from that of the information copying apparatus explained in the first embodiment. Therefore, the configuration of the copying unit will be explained. FIG. 14 is a functional block diagram of the configuration of the copying unit of the information copying apparatus according to the second embodiment. For the brevity of explanation, like reference signs refer to like functional units performing the same roles as those of the respective units shown in FIG. 8, and the detailed explanation thereof is omitted.

As shown in FIG. 8, a copying unit 1410 includes a converter 1411 in addition to the display-mode determining unit 810, the copy object determining unit 820, the copy controller 830, and the data buffer 840.

The converter 1411 is a processor that converts the NVML data 610 into the data format that can be displayed by the copy destination display processing unit 230, when the NVML data 610 is copied from the copy source display processing unit 220 into the copy destination display processing unit 230. Since the converter 1411 converts the data format of the data to be copied, the copying unit 1410 can convert the NVML data 610 into the data format that can be displayed by the copy destination display processing unit 230 to copy the NVML data 610.

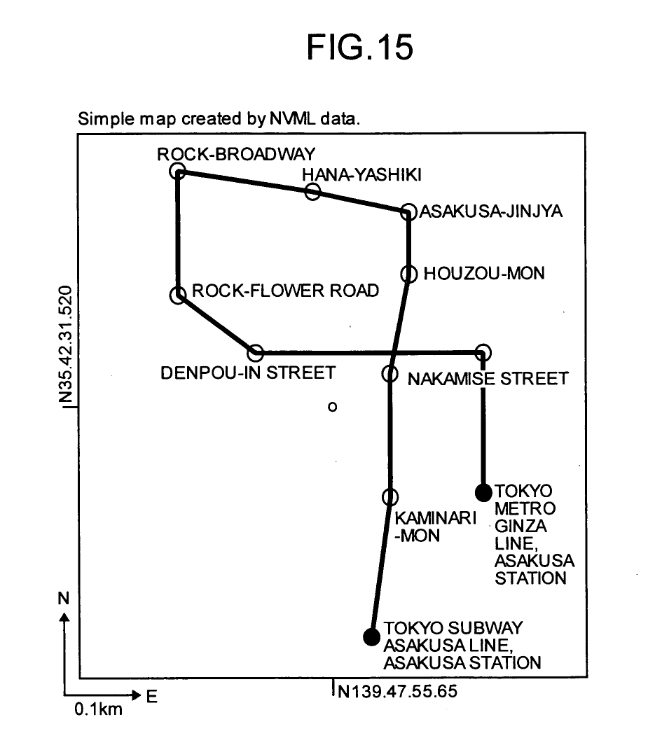

FIG. 15 depicts a display mode in which the copy destination display processing unit 230 displays data in the SVG format. FIG. 15 depicts a display mode in which the copying unit 1410 converts the NVML data 610 shown in FIG. 3 into data in the SVG format and copies the NVML data 610 into the copy destination display processing unit 230, and the copy destination display processing unit 230 displays the data in the SVG format.

According to the second embodiment, when the copying unit 1410 copies the NVML data 610, the NVML data is automatically converted to the data in the SVG format and copied. As a result, the copy destination display processing unit 230 can use the copied data directly for display.

According to the present invention, when the display mode data is created based on the display object data stored in the predetermined memory area and the display-mode designation data, the display mode corresponding to the display mode data is displayed on the window, and a part or the whole displayed display mode is selected on the window to perform copy operation to another window, the display-mode designation data and the display object data are copied in the memory area corresponding to the other window. As a result, there is an effect that the display mode can be changed and the display object data can be reused at the copy destination.

Furthermore, according to the present invention, when the copy destination does not have the display-mode designation data and the function for creating the display mode based on the display object data, the display object data is automatically converted into data format that can be displayed at the copy destination and copied. As a result, there is an effect that the copy destination can use the copied data directly for display.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An information copying apparatus comprising:
a display processing unit that creates display mode data based on display object data and display-mode designation data stored in a first memory area, and displays a display mode corresponding to the display mode data on a first window; and
a data copying unit that selects, when a copy operation for copying the display mode into a second window is performed, a part of or a whole of the display mode displayed on the window, and copies the display-mode designation data and the display object data into a second memory area corresponding to the second window.

2. The information copying apparatus according to claim 1, further comprising a function determining unit that determines whether a copy destination corresponding to the second window has a function for creating a display mode based on the display-mode designation data and the display object data, wherein
the data copying unit copies the display-mode designation data only when the copy destination has the function.

3. The information copying apparatus according to claim 2, further comprising:
a data determining unit that determines whether the copy destination has the display-mode designation data; and
a selection requesting unit that requests, upon the data determining unit determining that the copy destination has the display-mode designation data, a user to select whether to make a copy of the display-mode designation data, wherein
the data copying unit copies the display-mode designation data only when the user selects to make a copy.

4. The information copying apparatus according to claim 2, further comprising a data converting unit that converts, upon the function determining unit determining that the copy destination does not have the function, the display object data into other display object data that can be displayed by the copy destination, wherein
the copying unit copies the other display object data converted by the data converting unit.

5. The information copying apparatus according to claim 1, further comprising a display-mode determining unit that determines whether the display mode selected is created from the display-mode designation data and the display object data, wherein
the copying unit copies the display-mode designation data only when the display mode selected is created from the display-mode designation data and the display object data.

6. The information copying apparatus according to claim 1, wherein
the display-mode designation data is created by using an extensible stylesheet language, and
the display object data is created by using an extensible markup language.

7. The information copying apparatus according to claim 6, wherein the display object data is created by using a navigation markup language that is a language of the extensible markup language specification for describing a position and a route of a mobile object.

8. An information copying method comprising:
creating display mode data based on display object data and display-mode designation data stored in a first memory area;
displaying a display mode corresponding to the display mode data on a first window;
selecting, when a copy operation for copying the display mode into a second window is performed, a part of or a whole of the display mode displayed on the window; and
copying the display-mode designation data and the display object data into a second memory area corresponding to the second window.

9. The information copying method according to claim 8, further comprising determining whether a copy destination corresponding to the second window has a function for creating a display mode based on the display-mode designation data and the display object data, wherein
the copying includes copying the display-mode designation data only when the copy destination has the function.

10. The information copying method according to claim 9, further comprising:
determining whether the copy destination has the display-mode designation data; and
requesting, when it is determined that the copy destination has the display-mode designation data, a user to select whether to make a copy of the display-mode designation data, wherein
the copying includes copying the display-mode designation data only when the user selects to make a copy.

11. The information copying method according to claim 9, further comprising converting, when it is determined that the copy destination does not have the function, the display object data into other display object data that can be displayed by the copy destination, wherein
the copying includes copying the other display object data converted.

12. The information copying method according to claim 8, further comprising determining whether the display mode selected is created from the display-mode designation data and the display object data, wherein
the copying includes copying the display-mode designation data only when the display mode selected is created from the display-mode designation data and the display object data.

13. The information copying method according to claim 8, wherein
the display-mode designation data is created by using an extensible stylesheet language, and
the display object data is created by using an extensible markup language.

14. The information copying method according to claim 13, wherein the display object data is created by using a navigation markup language that is a language of the extensible markup language specification for describing a position and a route of a mobile object.

15. An information copying program making a computer execute:
creating display mode data based on display object data and display-mode designation data stored in a first memory area;
displaying a display mode corresponding to the display mode data on a first window;
selecting, when a copy operation for copying the display mode into a second window is performed, a part of or a whole of the display mode displayed on the window; and
copying the display-mode designation data and the display object data into a second memory area corresponding to the second window.

16. The information copying program according to claim 15, further making the computer execute determining whether a copy destination corresponding to the second window has a function for creating a display mode based on the display-mode designation data and the display object data, wherein
the copying includes copying the display-mode designation data only when the copy destination has the function.

17. The information copying program according to claim 16, further making the computer execute:
determining whether the copy destination has the display-mode designation data; and
requesting, when it is determined that the copy destination has the display-mode designation data, a user to select whether to make a copy of the display-mode designation data, wherein
the copying includes copying the display-mode designation data only when the user selects to make a copy.

18. The information copying program according to claim 16, further making the computer execute converting, when it is determined that the copy destination does not have the function, the display object data into other display object data that can be displayed by the copy destination, wherein
the copying includes copying the other display object data converted.

19. The information copying program according to claim 15, further making the computer execute determining whether the display mode selected is created from the display-mode designation data and the display object data, wherein
the copying includes copying the display-mode designation data only when the display mode selected is created from the display-mode designation data and the display object data.

20. The information copying program according to claim 15, wherein the display-mode designation data is created by using an extensible stylesheet language, and
the display object data is created by using an extensible markup language.

21. The information copying program according to claim 20, wherein the display object data is created by using a navigation markup language that is a language of the extensible markup language specification for describing a position and a route of a mobile object.

22. A computer-readable recording medium that stores an information copying program that makes a computer execute:
creating display mode data based on display object data and display-mode designation data stored in a first memory area;
displaying a display mode corresponding to the display mode data on a first window;
selecting, when a copy operation for copying the display mode into a second window is performed, a part of or a whole of the display mode displayed on the window; and
copying the display-mode designation data and the display object data into a second memory area corresponding to the second window.
